(19) United States
(12) Patent Application Publication
(10) Pub. No.: US 2004/0191624 A1
(43) Pub. Date: Sep. 30, 2004

(54) Electrolyte for alkaline battery and alkaline battery employing electrolyte

(76) Inventors: Mitsuo Shinoda, Yamaguchi (JP); Seiji Fuchino, Yamaguchi (JP); Tadayoshi Odahara, Yamaguchi (JP); Shigeo Hirayama, Hiroshima (JP)

Correspondence Address: YOUNG & THOMPSON, 745 SOUTH 23RD STREET 2ND FLOOR, ARLINGTON, VA, 22202

(21) Appl. No.: 10/486,971

(22) PCT Filed: Apr. 21, 2003
(86) PCT No.: PCT/JP03/05048

(30) Foreign Application Priority Data
Jun. 7, 2002 (JP) 2002-166382

(51) Int. Cl. H01M 10/26; H01M 4/42

(52) U.S. Cl. 429/206; 429/229

(57) ABSTRACT

It is an object of the invention to provide an electrolytic solution for alkaline batteries which inhibits hydrogen gas evolution and thereby prevents battery leakage and an alkaline battery containing the electrolytic solution. The electrolytic solution for alkaline batteries is characterized by containing aluminum at an ion concentration of 5 to 200 ppm.

### TECHNICAL FIELD

The present invention relates to an electrolytic solution for an alkaline battery and an alkaline battery containing the same.

### BACKGROUND ART

Electronic equipment such as camcorders and stereophones have been reducing in size, and batteries therefor have been required to have higher energy density.

Alkaline batteries containing an alkali solution as an electrolytic solution are employed in such small-sized electronic equipment. The alkaline batteries use, as an anode active material, zinc powder or zinc alloy powder that has a high hydrogen overvoltage and is relatively inexpensive. As an electrolytic solution, a solution prepared by dissolving potassium hydroxide in water in a concentration of about 40% by weight and saturating the aqueous solution with zinc oxide in order to reduce hydrogen gas evolution due to local cell formation thereby to prevent leakage is usually used.

In such an alkaline battery, zinc or zinc alloy powder as an anode active material is used as mixed with a gelling agent and an electrolytic solution into a gelatinous anode.

Zinc or zinc alloy powder used or to be used as an anode active material tends to be contaminated with impurities from other members after incorporation into a battery or in the course of its preparation. Impurities are also leached into the electrolytic solution.

If impurities are present in the anode active material or the electrolytic solution, corrosion is accelerated by the reaction of zinc or zinc alloy with an alkali solution to cause abnormal hydrogen gas evolution, which causes battery leakage.

An object of the present invention is to provide an electrolytic solution for alkaline batteries which reduces hydrogen gas evolution thereby to prevent battery leakage and an alkaline battery containing the electrolytic solution.

### DISCLOSURE OF THE INVENTION

As a result of investigations, the present inventors have found that the above object is accomplished by incorporating a given concentration of aluminum into an electrolytic solution.

The present invention has been reached based on the above finding and provides an electrolytic solution for alkaline batteries characterized by containing aluminum at an ion concentration of 5 to 200 ppm.

The present invention also provides an alkaline battery containing the above-described electrolytic solution.

### BRIEF DESCRIPTION OF THE DRAWING

FIG. 1 is a cross-section showing an example of the alkaline battery according to the present invention.

### BEST MODE FOR CARRYING OUT THE INVENTION

The electrolytic solution of alkaline batteries and the alkaline battery containing the same according to the present invention will be described in detail.

The electrolytic solution for alkaline batteries according to the-present invention contains aluminum at an ion concentration of 5 to 200 ppm, preferably 10 to 150 ppm. At ammonium ion concentrations lower than 5 ppm, it is impossible to inhibit hydrogen gas evolution and prevent battery leakage. Aluminum ion concentrations exceeding 100 ppm tend to cause a short circuit.

The following means are adopted to incorporate aluminum into an electrolytic solution in a prescribed concentration.

(1) Aluminum powder is added to an electrolytic solution.

(2) A water-soluble aluminum compound or an aqueous solution thereof is added to an electrolytic solution.

(3) Aluminum is incorporated into zinc alloy powder as an anode active material to have aluminum leached into an electrolytic solution. In this case, the aluminum content in the zinc alloy powder should be decided based on the amount of leached aluminum.

A prescribed concentration of aluminum can thus be incorporated into an electrolytic solution. The aluminum is present in the electrolytic solution in an ionized form or a salt form. The electrolytic solution into which aluminum is incorporated in the present invention is a potassium hydroxide aqueous solution having a concentration of about 40% by weight in which zinc oxide has been dissolved to saturation.

The alkaline battery of the present invention is then described. The alkaline battery of the invention is the one containing the above-described electrolytic solution and is otherwise conventional.

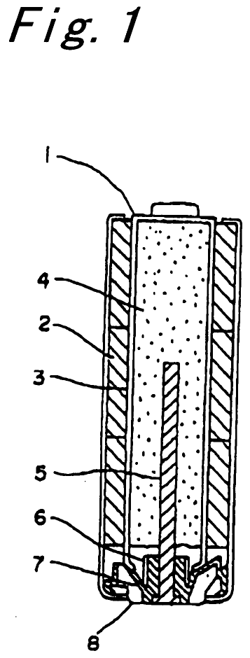

FIG. 1 is a cross-section showing an example of the alkaline battery of the present invention, in which numeral 1 indicates a cathode can; 2, a cathode; 3, a separator; 4, an anode; 5, an anode current collector; 6, a sealing cap; 7, a gasket; and 8, an anode terminal.

In FIG. 1, the anode 4 is a gel anode formed by mixing a zinc or zinc alloy powder as anode active material with the electrolytic solution containing aluminum at a given concentration and a gelling agent. The gelling agent which can be used includes polyvinyl alcohol, a polyacrylic acid salt, carboxymethyl cellulose, and alginic acid.

The alkaline battery of the present invention is inhibited from hydrogen gas evolution and therefore prevented from leakage.

The present invention will now illustrated in greater detail with reference to Examples.

### EXAMPLE 1

An alloying melt prepared according to a predetermined alloying composition was atomized to give a zinc alloy powder containing 0.013 wt % bismuth and 0.050 wt % indium.

A 40 wt % aqueous solution of potassium hydroxide was saturated with zinc oxide, and aluminum powder was added to the solution to an aluminum ion concentration of 50 ppm to prepare an electrolytic solution.

Gas evolution characteristics and battery characteristics were evaluated using the zinc alloy powder and the electrolytic solution. Gas evolution characteristics were evaluated by immersing 10 g of the zinc alloy powder in 5 ml of the electrolytic solution and measuring the gas evolution rate (μl/g/day) at 45° C. for a 3-day period. The result is shown in Table 1 in the column “gas evolution from powder”.

An alkaline-manganese battery shown in FIG. 1 (JIS LR6) was made using the zinc alloy powder as an anode. The battery was continuously discharged at a discharge resistance of 1 Ω to a cut-off voltage of 0.2 V. After the discharged alkaline-manganese battery was stored at 60° C. for 3 days, the amount of evolved gas was measured, which is shown in Table 1 as “amount of gas evolved inside battery” after constant resistance (1 Ω) discharging. The battery characteristics were evaluated by storing an alkaline battery (JIS LR6) at 20° C. for 7 days, continuously discharging the battery at a discharge resistance of 1 Ω, and measuring the discharge duration time until the voltage reduced to 0.9 V. The result obtained is shown in Table 1.

### EXAMPLE 2

Gas evolution characteristics and battery characteristics were evaluated in the same manner as in Example 1, except for using an electrolytic solution to which aluminum hydroxide had been added to give an aluminum ion concentration of 50 ppm. The results obtained are shown in Table 1.

### EXAMPLE 3

An alloying melt prepared according to a predetermined alloying composition was atomized to give a zinc alloy powder containing 0.013 wt % bismuth, 0.050 wt % indium, and 0.008 wt % aluminum.

A 40 wt % aqueous solution of potassium hydroxide was saturated with zinc oxide to prepare an electrolytic solution.

Gas evolution characteristics and battery characteristics were evaluated in the same manner as in Example 1. The results obtained are shown in Table 1. When 10 g of the zinc alloy powder was immersed in 5 ml of the electrolytic solution, the aluminum ion concentration of the electrolytic solution became 50 ppm.

### COMPARATIVE EXAMPLE 1

Gas evolution characteristics and battery characteristics were evaluated in the same manner as in Example 1, except for using an electrolytic solution prepared by saturating a 40 wt % potassium hydroxide aqueous solution with zinc oxide and adding no aluminum powder thereto. The results obtained are shown in Table 1.

TABLE 1

| | Zinc Alloy | | | Al Concentration in | | | | | |
|---|---|---|---|---|---|---|---|---|---|
| | Composition | | | Electrolytic Solution (ppm) | | | Gas Evolution | Amount of Gas | Relative |
| | (wt %) | | | Al | Al | | from powder | Evolved inside | Discharge |
| | Bi | In | Al | Powder | Compound | Not Added | (μl/g/day) | Battery (ml) | Duration(%) |
| Ex. 1 | 0.013 | 0.050 | — | 50 | — | — | 2.0 | 1.20 | 101 |
| Ex. 2 | 0.013 | 0.050 | — | — | 50 | — | 1.9 | 1.25 | 100 |
| Ex. 3 | 0.013 | 0.050 | 0.008 | — | — | 50 | 2.1 | 1.15 | 103 |
| Comp. Ex. 1 | 0.013 | 0.050 | — | — | — | — | 2.2 | 1.50 | 100 |

### Industrial Applicability

As described above in detail, the electrolytic solution according to the present invention provides an alkaline battery which is inhibited from hydrogen gas evolution and thereby prevented from leakage.

1. An electrolytic solution for alkaline batteries characterized by containing aluminum at an ion concentration of 5 to 200 ppm.

2. An electrolytic solution for alkaline batteries according to claim 1, wherein the aluminum is aluminum powder having been added to the electrolytic solution.

3. An electrolytic solution for alkaline batteries according to claim 1, wherein the aluminum is of a water-soluble aluminum compound or a solution thereof having been added to the electrolytic solution.

4. An electrolytic solution for alkaline batteries according to claim 1, wherein the aluminum is one having been leached from an aluminum-containing zinc alloy powder used as an anode active material.

5. An alkaline battery containing an electrolytic solution according to any one of claims 1 to 4.
